(19) United States
(12) Patent Application Publication
(10) Pub. No.: US 2013/0318538 A1
(43) Pub. Date: Nov. 28, 2013

(54) ESTIMATING A PERFORMANCE CHARACTERISTIC OF A JOB USING A PERFORMANCE MODEL

(71) Applicants: Abhishek Verma, Champaign, IL (US); Ludmila Cherkasova, Sunnyvale, CA (US)

(72) Inventors: Abhishek Verma, Champaign, IL (US); Ludmila Cherkasova, Sunnyvale, CA (US)

(21) Appl. No.: 13/982,732

(22) PCT Filed: Feb. 2, 2011
(86) PCT No.: PCT/US2011/023438

§ 371 Date: Jul. 30, 2013

(51) Int. Cl. G06F 9/50

(52) U.S. Cl. CPC G06F 9/50
USPC 718/104

(57) ABSTRACT

A job profile is received (302) that describes a job to be executed. A performance model is produced (304) based on the job profile and allocated amount of resources for the job, and a performance characteristic of the job is estimated (306) using the performance model.

### BACKGROUND

Many enterprises (such as companies, educational organizations, and government agencies) employ relatively large volumes of data that are often subject to analysis. A substantial amount of the data of an enterprise can be unstructured data, which is data that is not in the format used in typical commercial databases. Existing infrastructure may not be able to efficiently handle the processing of relatively large volumes of unstructured data.

### BRIEF DESCRIPTION OF THE DRAWINGS

Some embodiments are described with respect to the following figures:

FIG. 1 is a block diagram of an example arrangement that incorporates some implementations;

FIGS. 2A-2B are graphs illustrating map tasks and reduce tasks of a job in a MapReduce environment, according to some examples; and

FIG. 3 is a flow diagram of a process of estimating a performance characteristic of a job, according to some implementations.

### DETAILED DESCRIPTION

For processing relatively large volumes of unstructured data, a MapReduce framework provides a distributed computing platform can be employed. Unstructured data refers to data not formatted according to a format of a relational database management system. An open-source implementation of the MapReduce framework is Hadoop. The MapReduce framework is increasingly being used across an enterprise for distributed, advanced data analytics and to provide new applications associated with data retention, regulatory compliance, e-discovery, litigation, or other issues. Diverse applications can be run over the same data sets to efficiently utilize the resources of large distributed systems.

Generally, the MapReduce framework includes a master node and multiple slave nodes. A MapReduce job submitted to the master node is divided into multiple map tasks and multiple reduce tasks, which are executed in parallel by the slave nodes. The map tasks are defined by a map function, while the reduce tasks are defined by a reduce function. Each of the map and reduce functions are user-defined functions that are programmable to perform target functionalities.

The map function processes corresponding segments of input data to produce intermediate results, where each of the multiple map tasks (that are based on the map function) process corresponding segments of the input data. For example, the map tasks process input key-value pairs to generate a set of intermediate key-value pairs. The reduce tasks (based on the reduce function) produce an output from the intermediate results. For example, the reduce tasks merge the intermediate values associated with the same intermediate key.

More specifically, the map function takes input key-value pairs (k₁, v₁) and produces a list of intermediate key-value pairs (k₂, v₂). The intermediate values associated with the same key k₂ are grouped together and then passed to the reduce function. The reduce function takes an intermediate key k₂ with a list of values and processes them to form a new list of values (v₃), as expressed below.

map(k₁,v₁)→list(k₂,v₂).

reduce(k₂,list(v₂))→list(v₃)

Although reference is made to the MapReduce framework in some examples, it is noted that techniques or mechanisms according to some implementations can be applied in other distributed processing frameworks. More generally, map tasks are used to process input data to output intermediate results, based on a predefined function that defines the processing to be performed by the map tasks. Reduce tasks take as input partitions of the intermediate results to produce outputs, based on a predefined function that defines the processing to be performed by the reduce tasks. The map tasks are considered to be part of a map stage, whereas the reduce tasks are considered to be part of a reduce stage. In addition, although reference is made to unstructured data in some examples, techniques or mechanisms according to some implementations can also be applied to structured data formatted for relational database management systems.

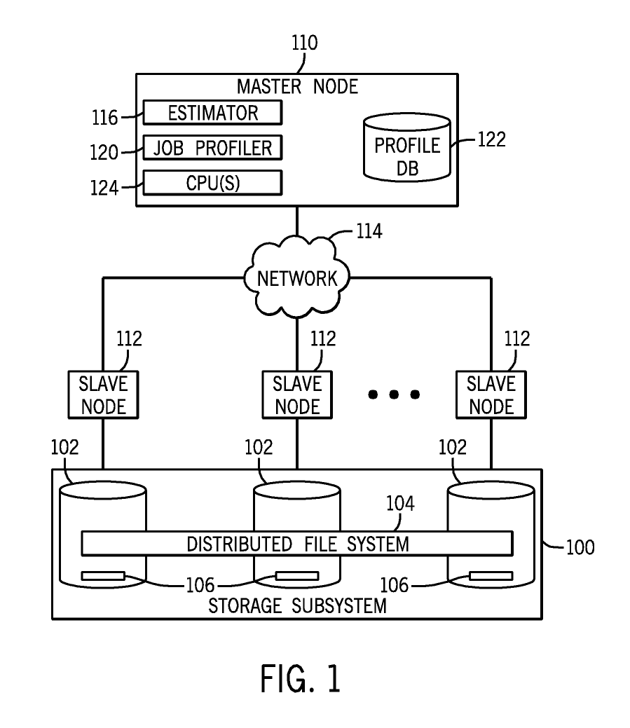

FIG. 1 illustrates an example arrangement that provides a distributed processing framework that includes mechanisms according to some implementations for estimating performance characteristics of jobs to be executed in the distributed processing framework. As depicted in FIG. 1, a storage subsystem 100 includes multiple storage modules 102, where the multiple storage modules 102 can provide a distributed file system 104. The distributed file system 104 stores multiple segments 106 of input data across the multiple storage modules 102. The distributed file system 104 can also store outputs of map and reduce tasks.

The storage modules 102 can be implemented with storage devices such as disk-based storage devices or integrated circuit storage devices. In some examples, the storage modules 102 correspond to respective different physical storage devices. In other examples, plural ones of the storage modules 102 can be implemented on one physical storage device, where the plural storage modules correspond to different partitions of the storage device.

The system of FIG. 1 further includes a master node 110 that is connected to slave nodes 112 over a network 114. The network 114 can be a private network (e.g., a local area network or wide area network) or a public network (e.g., the Internet), or some combination thereof. The master node 110 includes one or more central processing units (CPUs) 124. Each slave node 112 also includes one or more CPUs (not shown). Although the master node 110 is depicted as being separate from the slave nodes 112, it is noted that in alternative examples, the master node 112 can be one of the slave nodes 112.

A “node” refers generally to processing infrastructure to perform computing operations. A node can refer to a computer, or a system having multiple computers. Alternatively, a node can refer to a CPU within a computer. As yet another example, a node can refer to a processing core within a CPU that has multiple processing cores. More generally, the system can be considered to have multiple processors, where each processor can be a computer, a system having multiple computers, a CPU, a core of a CPU, or some other physical processing partition.

In accordance with some implementations, the master node 110 is configured to perform scheduling of jobs on the slave nodes 112. The slave nodes 112 are considered the working nodes within the cluster that makes up the distributed processing environment.

Each slave node 112 has a fixed number of map slots and reduce slots, where map tasks are run in respective map slots, and reduce tasks are run in respective reduce slots. The number of map slots and reduce slots within each slave node 112 can be preconfigured, such as by an administrator or by some other mechanism. The available map slots and reduce slots can be allocated to the jobs. The map slots and reduce slots are considered the resources used for performing map and reduce tasks. A “slot” can refer to a time slot or alternatively, to some other share of a processing resource that can be used for performing the respective map or reduce task. Depending upon the load of the overall system, the number of map slots and number of reduce slots that can be allocated to any given job can vary.

The slave nodes 112 can periodically (or repeatedly) send messages to the master node 110 to report the number of free slots and the progress of the tasks that are currently running in the corresponding slave nodes. Based on the availability of free slots (map slots and reduce slots) and the rules of a scheduling policy, the master node 110 assigns map and reduce tasks to respective slots in the slave nodes 112.

Each map task processes a logical segment of the input data that generally resides on a distributed file system, such as the distributed file system 104 shown in FIG. 1. The map task applies the map function on each data segment and buffers the resulting intermediate data. This intermediate data is partitioned for input to the multiple reduce tasks.

The reduce stage (that includes the reduce tasks) has three phases: shuffle phase, sort phase, and reduce phase. In the shuffle phase, the reduce tasks fetch the intermediate data from the map tasks. In the sort phase, the intermediate data from the map tasks are sorted. An external merge sort is used in case the intermediate data does not fit in memory. Finally, in the reduce phase, the sorted intermediate data (in the form of a key and all its corresponding values, for example) is passed on the reduce function. The output from the reduce function is usually written back to the distributed file system 104.

The master node 110 of FIG. 1 includes a job profiler 120 that is able to create a job profile for a given job, in accordance with some implementations. The job profile describes characteristics of the given job to be performed by the system of FIG. 1. A job profile created by the job profiler 120 can be stored in a job profile database 122. The job profile database 122 can store multiple job profiles, including job profiles of jobs that have executed in the past.

In other implementations, the job profiler 120 and/or profile database 122 can be located at another node.

The master node 110 also includes a performance characteristic estimator 116 according to some implementations. The estimator 116 is able to produce an estimated performance characteristic, such as an estimated completion time, of a job, based on the corresponding job profile and resources (e.g., numbers of map slots and reduce slots) allocated to the job. The estimated completion time refers to either a total time duration for the job, or an estimated time at which the job will complete. In other examples, other performance characteristics of a job can be estimated, such as cost of the job, error rate of the job, and so forth.

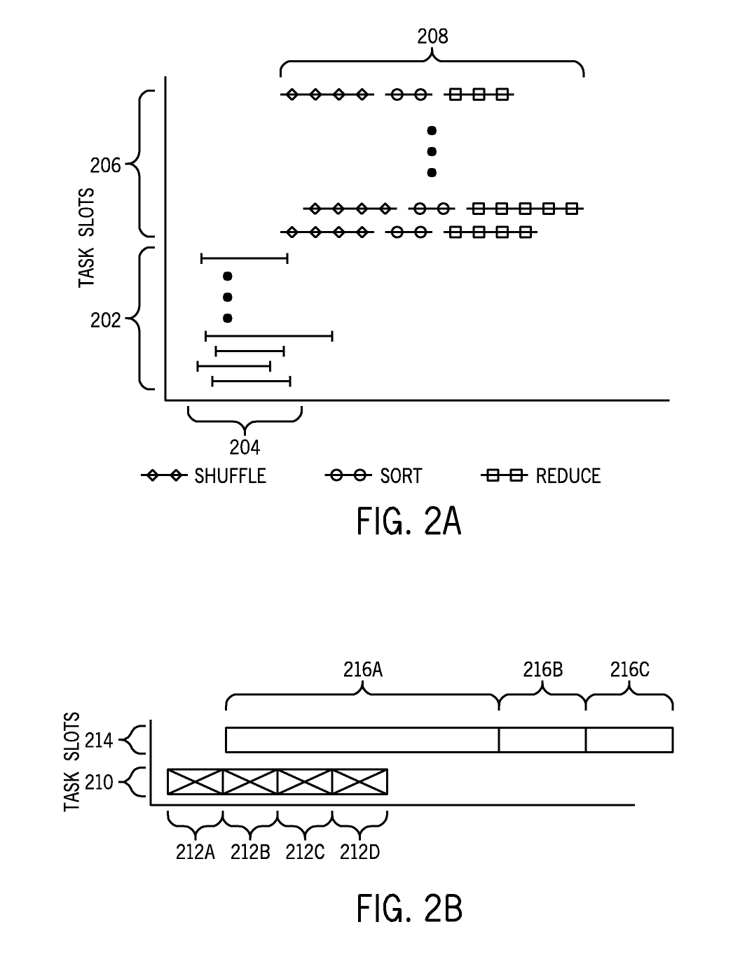

FIGS. 2A and 2B illustrate differences in completion times of performing map and reduce tasks of a given job due to different allocations of map slots and reduce slots. FIG. 2A illustrates an example in which there are 64 map slots and 64 reduce slots allocated to the given job. The example also assumes that the total input data to be processed for the given job can be separated into 64 partitions. Since each partition is processed by a corresponding different map task, the given job includes 64 map tasks. Similarly, 64 partitions of intermediate results output by the map tasks can be processed by corresponding 64 reduce tasks. Since there are 64 map slots allocated to the map tasks, the execution of the given job can be completed in a single map wave.

As depicted in FIG. 2A, the 64 map tasks are performed in corresponding 64 map slots 202, in a single wave (represented generally as 204). Similarly, the 64 reduce tasks are performed in corresponding 64 reduce slots 206, also in a single reduce wave 208, which includes shuffle, sort, and reduce phases represented by different line patterns in FIG. 2A.

A “map wave” refers to an iteration of the map stage. If the number of allocated map slots is greater than or equal to the number of map tasks, then the map stage can be completed in a single iteration (single wave). However, if the number of map slots allocated to the map stage is less than the number of map tasks, then the map stage would have to be completed in multiple iterations (multiple waves). Similarly, the number of iterations (waves) of the reduce stage is based on the number of allocated reduce slots as compared to the number of reduce tasks.

FIG. 2B illustrates a different allocation of map slots and reduce slots. Assuming the same given job (input data that is divided into 64 partitions), if the number of resources allocated is reduced to 16 map slots and 22 reduce slots, for example, then the completion time for the given job will change (increase). FIG. 2B illustrates execution of map tasks in the 16 map slots 210. In FIG. 2B, instead of performing the map tasks in a single wave as in FIG. 2A, the example of FIG. 2B illustrates four waves 212A, 212B, 212C, and 212D of map tasks. The reduce tasks are performed in the 22 reduce slots 214, in three waves 216A, 216B, and 216C. The completion time of the given job in the FIG. 2B example is greater than the completion time in the FIG. 2A example, since a smaller amount of resources was allocated to the given job in the FIG. 2B example than in the FIG. 2A example.

Thus, it can be observed from the examples of FIGS. 2A and 2B that it can be difficult to predict the execution time of any given job when different amounts of resources are allocated to the job.

In accordance with some implementations, mechanisms are provided to estimate a job completion time of a job as a function of allocated resources. By being able to estimate a job completion time as a function of allocated resources, the master node 110 (FIG. 1) is able to determine whether the given job is able to achieve a performance goal associated with the given job. In some examples, the performance goal is expressed as a specific deadline, or some other indication of a time duration within which the job should be executed. Other performance goals can be used in other examples. For example, a performance goal can be expressed as a service level objective (SLO), which specifies a level of service to be provided (expected performance, expected time, expected cost, etc.).

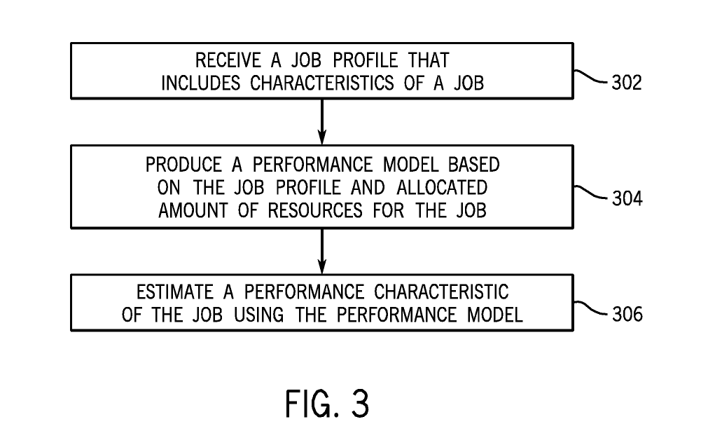

FIG. 3 is a flow diagram of a process according to some implementations. The process includes receiving (at 302) a job profile that includes characteristics of a particular job. Receiving the job profile can refer to a given node (such as the master node 110) receiving the job profile that was created at another node. Alternatively, receiving the job profile can involve the given node creating the job profile, such as by the job profiler 120 in FIG. 1.

Next, a performance model is produced (at 304) based on the job profile and allocated amount of resources for the job (e.g., allocated number of map slots and allocated number of reduce slots). Using the performance model, a performance characteristic of the job is estimated (at 306). For example, this estimation can be performed by the performance characteristic estimator 116 in FIG. 1. In some implementations, the estimated performance characteristic is an estimated completion time of the job (an amount of time for the job to complete execution) given the allocated resources (e.g., number of map slots and number of reduce slots). Alternatively, in other implementations, other performance characteristics of the job on a given set of resources can be estimated.

In some implementations, the particular job is executed in a given environment (including a system having a specific arrangement of physical machines and respective map and reduce slots in the physical machines), and the job profile and performance model are applied with respect to the particular job in this given environment.

A job profile reflects performance invariants that are independent of the amount of resources assigned to the job over time, for each of the phases of the job: map, shuffle, sort, and reduce phases.

The map stage includes a number of map tasks. To characterize the distribution of the map task durations and other invariant properties, the following metrics can be specified in some examples:

(Mₘᵢₙ, M_{avg}, Mₘₐₓ, AvgSize_{M}^{input}, Selectivity_{M}), where
Mₘᵢₙ is the minimum map task duration. Since the shuffle phase starts when the first map task completes, Mₘᵢₙ is used as an estimate for the shuffle phase beginning.
M_{avg} is the average duration of map tasks to indicate the average duration of a map wave.
Mₘₐₓ is the maximum duration of a map task. Since the sort phase of the reduce stage can start only when the entire map stage is complete, i.e., all the map tasks complete, Mₘₐₓ is used as an estimate for a worst map wave completion time.
AvgSize_{M}^{input} is the average amount of input data for a map stage. This parameter is used to estimate the number of map tasks to be spawned for a new data set processing.
Selectivity_{M} is the ratio of the map data output size to the map data input size. It is used to estimate the amount of intermediate data produced by the map stage as the input to the reduce stage (note that the size of the input data to the map stage is known).

The duration of the map tasks is affected by whether the input data is local to the machine running the task (local node), or on another machine on the same rack (local rack), or on a different machine of a different rack (remote rack). These different types of map tasks are tracked separately. The foregoing metrics can be used to improve the prediction accuracy of the performance model and decision making when the types of available map slots are known.

As described earlier, the reduce stage includes the shuffle, sort and reduce phases. The shuffle phase begins only after the first map task has completed. The shuffle phase (of any reduce wave) completes when the entire map stage is complete and all the intermediate data generated by the map tasks have been shuffled to the reduce tasks.

The completion of the shuffle phase is a prerequisite for the beginning of the sort phase. Similarly, the reduce phase begins only after the sort phase is complete. Thus the profiles of the shuffle, sort, and reduce phases are represented by their average and maximum time durations. In addition, for the reduce phase, the reduce selectivity, denoted as Selectivity_{R}, is computed, which is defined as the ratio of the reduce data output size to its data input size.

The shuffle phase of the first reduce wave may be different from the shuffle phase that belongs to the subsequent reduce waves (after the first reduce wave). This can happen because the shuffle phase of the first reduce wave overlaps with the map stage and depends on the number of map waves and their durations. Therefore, two sets of measurements are collected: (Sh_{avg}¹,Shₘₐₓ¹) for a shuffle phase of the first reduce wave (referred to as the “first shuffle phase”), and (Sh_{avg}^{typ},Shₘₐₓ^{typ}) for the shuffle phase of the subsequent reduce waves (referred to as “typical shuffle phase”). Since techniques according to some implementations are looking for the performance invariants that are independent of the amount of allocated resources to the job, a shuffle phase of the first reduce wave is characterized in a special way and the parameters (Sh_{avg}¹ and Shₘₐₓ¹) reflect only durations of the non-overlapping portions (non-overlapping with the map stage) of the first shuffle. In other words, the durations represented by Sh_{avg}¹ and Shₘₐₓ¹ represent portions of the duration of the shuffle phase of the first reduce wave that do not overlap with the map stage.

Thus, the job profile in the shuffle phase is characterized by two pairs of measurements:

(Sh_{avg}¹,Shₘₐₓ¹), (Sh_{avg}^{typ},Shₘₐₓ^{typ}).

If the job execution has only a single reduce wave, the typical shuffle phase duration is estimated using the sort benchmark (since the shuffle phase duration is defined entirely by the size of the intermediate results output by the map stage).

Once the job profile is provided, then a performance model that is based on the job profile can be produced (304 in FIG. 3). In some implementations, the performance model is based on the job profile and lower and upper bounds of time durations of different phases of the job. The performance model is also produced based on an allocated amount of resources for the job (e.g., allocated number of map slots and allocated number of reduce slots). Such a performance model can be used for predicting the job completion time as a function of the job input data set and the allocated resources, where the job input data set refers to the input data to the job that is to be performed.

In some implementations, the performance model is characterized by lower and upper bounds for a makespan (a completion time of the job) of a given set of n (n>1) tasks that are processed by k (k>1) servers (or by k slots in a MapReduce environment). Let T₁,T₂, . . . , Tₙ be the durations of n tasks of a given job. Let k be the number of slots that can each execute one task at a time. The assignment of tasks to slots is done using a simple, online, greedy algorithm, e.g., assign each task to the slot with the earliest finishing time.

Let μ=(Σᵢ₋₁ⁿTᵢ)/n and λ=max, {Tᵢ} be the mean and maximum durations of the n tasks, respectively. The makespan of the greedy task assignment is at least n·μ/k and at most (n−1)·μ/k+λ. The lower bound is trivial, as the best case is when all n tasks are equally distributed among the k slots (or the overall amount of work is processed as fast as it can by k slots). Thus, the overall makespan (completion time of the job) is at least n·μ/k (lower bound of the completion time).

For the upper bound of the completion time for the job, the worst case scenario is considered, i.e., the longest task (T)∈(T₁,T₂, . . . , Tₙ) with duration λ is the last task processed. In this case, the time elapsed before the last task is scheduled is (Σᵢ₌₁ⁿ⁻¹Tᵢ)/k≦(n−1)·μ/k. Thus, the makespan of the overall assignment is at most (n−1)·μ/k+λ. These bounds are particularly useful when λ<<n·μ/k, in other words, when the duration of the longest task is small as compared to the total makespan.

The difference between lower and upper bounds (of the completion time) represents the range of possible job completion times due to non-determinism and scheduling. As discussed below, these lower and upper bounds, which are part of the properties of the performance model, are used to estimate a completion time for a corresponding job J.

The given job J has a given profile created by the job profiler 120 (FIG. 1) or extracted from the profile database 122. Let J be executed with a new input dataset that can be partitioned into N_{M} map tasks and N_{R} reduce tasks. Let S_{M} and S_{R} be the number of map slots and the number of reduce slots, respectively, allocated to job J.

Let M_{avg} and Mₘₐₓ be the average and maximum time durations of map tasks (defined by the job J profile). Then, based on the Makespan theorem, the lower and upper bounds on the duration of the entire map stage (denoted as T_{M}^{UP} and T_{M}^{up}, respectively) are estimated as follows:

T_{M}^{low}=N_{M}/S_{M}·M_{avg},

T_{M}^{up}=(N_{M}−1)/S_{M}·M_{avg}+Mₘₐₓ,

Stated differently, the lower bound of the duration of the entire map stage is based on a product of the average duration (M_{avg}) of map tasks multiplied by the ratio of the number map tasks (N_{M}) to the number of allocated map slots (S_{M}). The upper bound of the duration of the entire map stage is based on a sum of the maximum duration of map tasks (Mₘₐₓ) and the product of M_{avg} with (N_{M}−1)/S_{M}. Thus, it can be seen that the lower and upper bounds of durations of the map stage are based on properties of the job J profile relating to the map stage, and based on the allocated number of map slots.

The reduce stage includes shuffle, sort and reduce phases. Similar to the computation of the lower and upper bounds of the map stage, the lower and upper bounds of time durations for each of the shuffle phase (T_{Sh}^{low},T_{Sh}^{low}), sort phase (T_{Sort}^{low},T_{Sort}^{up}), and reduce phase (T_{R}^{low},T_{R}^{up}) are computed. The computation of the Makespan theorem is based on the average and maximum durations of the tasks in these phases (respective values of the average and maximum time durations of the shuffle phase, the average and maximum time durations of the sort phase, and the average and maximum time duration of the reduce phase) and the numbers of reduce tasks N_{R} and allocated reduce slots S_{R}, respectively. The formulae for calculating (T_{Sh}^{low},T_{Sh}^{low}), (T_{Sort}^{low},T_{Sort}^{up}), and (T_{R}^{low},T_{R}^{up}) are similar to the formulate for calculating T_{M}^{up} and T_{M}^{up} set forth above, except variables associated with the reduce tasks and reduce slots and the respective phases of the reduce stage are used instead.

The subtlety lies in estimating the duration of the shuffle phase. As noted above, the first shuffle phase is distinguished from the task durations in the typical shuffle phase (which is a shuffle phase subsequent to the first shuffle phase). As noted above, the first shuffle phase includes measurements of a portion of the first shuffle phase that does not overlap the map stage. The portion of the typical shuffle phase in the subsequent reduce waves (after the first reduce wave) is computed as follows:

$$\begin{matrix}{T}_{Sh}^{low} = ( \frac{{N}_{R}}{{S}_{R}} - 1 ) \cdot {Sh}_{avg}^{typ} , \\ {T}_{Sh}^{up} = ( \frac{{N}_{R} - 1}{{S}_{R}} - 1 ) \cdot {Sh}_{avg}^{typ} + {Sh}_{avg}^{typ} .\end{matrix}$$

where Sh_{avg}^{typ} is the average duration of a typical shuffle phase, and Shₘₐₓ^{typ} is the average duration of the typical shuffle phase. The formulae for the lower and upper bounds of the overall completion time of job J are as follows:

T_{J}^{low}=T_{M}^{low}+Sh_{avg}¹+T_{Sh}^{low}+T_{Sort}^{low}+T_{R}^{low},

T_{J}^{up}=T_{M}^{up}+Shₘₐₓ¹+T_{Sh}^{up}+T_{Sort}^{up}+T_{R}^{up},

where Sh_{avg}¹ is the average duration of the first shuffle phase, and Shₘₐₓ¹ is the maximum duration of the first shuffle phase. T_{J}^{low} and T_{J}^{up} represent optimistic and pessimistic predictions (lower and upper bounds) of the job J completion time. Thus, it can be seen that the lower and upper bounds of durations of the job J are based on properties of the job J profile and based on the allocated numbers of map and reduce slots. The properties of the performance model, which include T_{J}^{low} and T_{J}^{up} in some implementations, are thus based on both the job profile as well as allocated numbers of map and reduce slots.

In some implementations, estimates based on the average value between the lower and upper bounds tend to be closer to the measured duration. Therefore, T_{J}^{avg} is defined as follows:

T_{J}^{avg}=(T_{M}^{up}+)T_{J}^{low}/2.

In some implementations, the value T_{J}^{avg} is considered the estimated completion time for job J (estimated at 306 in FIG. 3). In other implementations, other estimated time duration based on T_{J}^{low} and T_{J}^{up} can be derived, such as a weighted average or the application of some other predefined function based on the lower and upper bounds (T_{J}^{low} and T_{J}^{up}).

The estimation of a performance characteristic of a job, such as its completion time, can be computed relatively quickly, since the calculations as discussed above are relatively simple. As a result, the master node 110 (FIG. 1) or other decision maker in a distributed processing framework (such as a MapReduce framework) can quickly obtain such performance characteristic information of a job to make decisions, such as scheduling decisions, resource allocation decisions, and so forth.

Machine-readable instructions of modules described above (including 116, 120, 122 in FIG. 1) are loaded for execution on one or more CPUs (such as 124 in FIG. 1). A CPU can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving (302), in a system having a plurality of processors, a job profile that includes characteristics of a job to be executed, wherein the characteristics of the job profile relate to map tasks and reduce tasks of the job, wherein the map tasks produce intermediate results based on segments of input data, and the reduce tasks produce an output based on the intermediate results;
producing (304), by the system, a performance model based on the job profile and an allocated amount of resources for the job; and
estimating (306), by the system, a performance characteristic of the job using the performance model.

2. The method of claim 1, further comprising:
determining, by the system based on the estimated performance characteristic, whether a performance goal of the job will be satisfied.

3. The method of claim 2, further comprising receiving an indication of the allocated amount of resources for the job, wherein the allocated amount of resources comprises an allocated number of map slots and number of reduce slots, wherein the map tasks are performed in the map slots, and the reduce tasks are performed in the reduce slots.

4. The method of claim 1, wherein estimating the performance characteristic comprises estimating a completion time of the job.

5. The method of claim 1, wherein producing the performance model comprises producing the performance model having a lower bound and an upper bound of the performance characteristic.

6. The method of claim 5, wherein the performance characteristic is a completion time of a job, the method further comprising:
computing the lower bound based on a number of the map tasks, a number of reduce tasks, a number of allocated map slots, a number of allocated reduce slots, an average time duration of a map task, an average time duration of a shuffle phase in a reduce stage, an average time duration of a sort phase in the reduce stage, and an average time duration of a reduce phase in the reduce stage, wherein the reduce stage includes the reduce tasks; and
computing the upper bound based on the number of the map tasks, the number of reduce tasks, the number of allocated map slots, the number of allocated reduce slots, the average time duration of a map task, a maximum time duration of a map task, the average time duration of the shuffle phase, a maximum time duration of the shuffle phase, the average time duration of the sort phase, a maximum time duration of the sort phase, the average time duration of the reduce phase, and a maximum time duration of the reduce phase.

7. The method of claim 1, wherein receiving the job profile including the characteristics of the job includes receiving the job profile including plural ones of: a minimum time duration of a map task, an average time duration of a map task, a maximum time duration of a map task, an average size of input data for a map task, an average time duration of a reduce task, and a maximum time duration of a reduce task.

8. The method of claim 7, wherein the job profile further includes: a parameter indicating a ratio between an output data size of a map stage that includes the map tasks and an input data size to the map stage, and a parameter indicating a ratio between an output data size and an input data size associated with a reduce stage that includes the reduce tasks.

9. An article comprising at least one machine-readable storage medium storing instructions that upon execution cause a system having a processor to perform a method according to any of claims 1-8.

10. A system comprising:
storage media (122) to store a job profile, wherein the job profile describes a job including a map stage to produce an intermediate result based on input data, and a reduce stage to produce an output based on the intermediate result; and
at least one processor (124) to:
produce parameters of a performance model based on the job profile and an allocated amount of resources for the job; and
generate an estimated performance characteristic of the job using the performance model.

11. The system of claim 10, wherein the parameters include an upper bound of the performance characteristic and a lower bound of the performance characteristic.

12. The system of claim 10, wherein the performance characteristic is an estimated completion time of the job.

13. The system of claim 12, wherein the at least one processor is to further:
compute the lower bound based on a number of map tasks in the map stage, a number of reduce tasks in the reduce stage, a number of allocated map slots, a number of allocated reduce slots, an average time duration of a map task, an average time duration of a shuffle phase in the reduce stage, an average time duration of a sort phase in the reduce stage, and an average time duration of a reduce phase in the reduce stage; and
compute the upper bound based on the number of the map tasks, the number of the reduce tasks, the number of allocated map slots, the number of allocated reduce slots, the average time duration of a map task, a maximum time duration of a map task, the average time duration of the shuffle phase, a maximum time duration of the shuffle phase, the average time duration of the sort phase, a maximum time duration of the sort phase, the average time duration of the reduce phase, and a maximum time duration of the reduce phase.

14. The system of claim 10, wherein the allocated amount of resources includes a number of map slots and a number of reduce slots on physical machines, wherein map tasks of the map stage are performed in the map slots, and reduce tasks of the reduce stage are performed in the reduce slots.

15. The system of claim 10, wherein the job profile includes parameters selected from among a minimum time duration of a map task in the map stage, an average time duration of a map task in the map stage, a maximum time duration of a map task in the map stage, an average size of input data for a map task in the map stage, an average duration of a phase of the reduce stage, and a maximum time duration of a phase in the reduce stage.
